(19) United States
(12) Patent Application Publication
(10) Pub. No.: US 2025/0036935 A1
(43) Pub. Date: Jan. 30, 2025

(54) COUPLED PHYSICS-INFORMED NEURAL NETWORK FOR SOLVING DISPLACEMENT DISTRIBUTION OF BOUNDED VIBRATION STRING UNDER UNKNOWN EXTERNAL DRIVING FORCE

(71) Applicant: DALIAN UNIVERSITY OF TECHNOLOGY, Dalian, Liaoning (CN)

(72) Inventors: Ximing SUN, Dalian, Liaoning (CN); Aina WANG, Dalian, Liaoning (CN); Pan QIN, Dalian, Liaoning (CN)

(21) Appl. No.: 18/280,581

(22) PCT Filed: May 17, 2023
(86) PCT No.: PCT/CN2023/094679

§ 371 Date: Sep. 6, 2023

(30) Foreign Application Priority Data
Dec. 6, 2022 (CN) 202211555055.X

(51) Int. Cl. G06N 3/08; G01M 99/00; G06N 3/045

(52) U.S. Cl. CPC G06N 3/08; G01M 99/007; G06N 3/045

(57) ABSTRACT

A coupled physics-informed neural network for solving displacement distribution of a bounded vibration string under an unknown external driving force is provided. A novel PINN is proposed, called C-PINN, used for solving the displacement distribution of the bounded vibration string under an external driving force with little or even no priori information. It comprises two neural networks: NetU and NetG. NetU is used for approximating satisfying the displacement distribution of the bounded vibration string under study. NetG is used for regularizing u in the NetU to satisfy the displacement distribution of the approximation of NetU. The two networks are integrated into a data-physics-hybrid loss function. In addition, a proposed hierarchical training strategy is used for optimizing the loss function and realizing the coupling of the two networks. Finally, the performance of the C-PINN in solving the displacement distribution of the bounded vibration string under the external driving force is verified.

### TECHNICAL FIELD

The present invention belongs to the field of solving partial differential equations by neural networks, and relates to a coupled physics-informed neural network for solving displacement distribution of a bounded vibration string under an unknown external driving force.

### BACKGROUND

The partial differential equation (PDE) is one of the expressions used for describing the spatiotemporal dependence. Therefore, the partial differential equation is widely used to model physical phenomena such as medical treatment, engineering, economy and weather. At present, there are several classical numerical methods for solving PDE successfully, such as the finite difference method (G. D. Smith, G. D. Smith, and G. D. S. Smith, Numerical solution of partial differential equations: finite difference methods. Oxford university press, 1985), and finite element method (G. Dziuk and C. M. Elliott, “Finite element methods for surface pdes,” Acta Numerica, vol. 22, pp. 289-396, 2013). It is worth noting that the numerical solution method is a tricky problem in the aspect of computational complexity.

In the numerical method for solving PDE, the Galerkin method is a well-known calculation method which uses the linear combination of basis functions to approximate the solution of PDE (Ciarlet P G. The finite element method for elliptic problems [M]. Society for Industrial and Applied Mathematics, 2002). Inspired by this, in some work, Zobeiry et al., Cuomo et al., and Chen et al., replaced the linear combination of basis functions with machine learning models (Zobeiry N, Humfeld K D. A physics-informed machine learning approach for solving heat transfer equation in advanced manufacturing and engineering applications [J]. Engineering Applications of Artificial Intelligence, 2021, 101: 104232. Cuomo S, Di Cola V S, Giampaolo F, et al. Scientific Machine Learning through Physics-Informed Neural Networks: Where we are and What's next [J]. arXiv preprint arXiv: 2201.05624, 2022. Chen W, Wang Q, Hesthaven J S, et al. Physics-informed machine learning for reduced-order modeling of nonlinear problems [J]. Journal of computational physics, 2021, 446:110666) to construct data-efficient and physics-informed methods for solving PDEs. The successful application of deep learning methods in various fields such as image (M. Ye, J. Shen, G. Lin, T. Xiang, L. Shao, and S. C. Hoi, “Deep learning for person re-identification: A survey and outlook,” IEEE transactions on pattern analysis and machine intelligence, vol. 44, no. 6, pp. 2872-2893, 2021), text (D. Nurseitov, K. Bostanbekov, M. Kanatov, A. Alimova, A. Abdallah, and G. Abdimanap, “Classification of handwritten names of cities and handwritten text recognition using various deep learning models,” arXiv preprint arXiv:2102.04816, 2021) and speech recognition (L. Deng, J. Li, J.-T. Huang, K. Yao, D. Yu, F. Seide, M. Seltzer, G. Zweig, X. He, J. Williams et al., “Recent advances in deep learning for speech research at microsoft,” in 2013 IEEE international conference on acoustics, speech and signal processing. IEEE, 2013, pp. 8604-8608) ensures that they can replace the linear combination of basis functions for solving the partial differential equation. Therefore, the use of the excellent approximation ability of neural networks to solve the partial differential equation is a natural idea and has been previously researched in various forms (A. J. Meade Jr and A. A. Fernandez, “The numerical solution of linear ordinary differential equations by feedforward neural networks,” Mathematical and Computer Modelling, vol. 19, no. 12, pp. 1-25, 1994. I. E. Lagaris, A. Likas, and D. I. Fotiadis, “Artificial neural networks for solving ordinary and partial differential equations,” IEEE transactions on neural networks, vol. 9, no. 5, pp. 987-1000, 1998. I. E. Lagaris, A. C. Likas, and D. G. Papageorgiou, “Neural-network methods for boundary value problems with irregular boundaries,” IEEE Transactions on Neural Networks, vol. 11, no. 5, pp. 1041-1049, 2000). Raissi et al. introduce the framework of the physics-informed neural network (PINN) to solve the forward problem (Raissi M, Perdikaris P, Karniadakis G E. Physics-informed neural networks: A deep learning framework for solving forward and inverse problems involving nonlinear partial differential equations [J]. Journal of Computational physics, 2019, 378: 686-707), while respecting any given physical laws governed by PDEs, including the nonlinear operator, initial, and boundary conditions. Within the PINN framework, Mao et al. (Mao Z, Jagtap A D, Karniadakis G E. Physics-informed neural networks for high-speed flows [J]. Computer Methods in Applied Mechanics and Engineering, 2020, 360: 112789) and He et al. (He Q Z, Barajas-Solano D, Tartakovsky G, et al. Physics-informed neural networks for multiphysics data assimilation with application to subsurface transport [J]. Advances in Water Resources, 2020, 141: 103610) fully consider sparse observation data and physical knowledge to construct loss functions. The solving scheme of any spatiotemporal dependence is obtained by training the loss functions. The solution of spatiotemporal dependence is obtained through the training of the loss functions. Approximate solutions obtained by machine learning and deep learning are meshless, and there is no problem in the balance accuracy and the efficiency of mesh formation.

Raissi et al. also propose that it is potential for using the PINN to solve inverse problems (Raissi M, Perdikaris P, Karniadakis G E. Physics-informed neural networks: A deep learning framework for solving forward and inverse problems involving nonlinear partial differential equations [J]. Journal of Computational physics, 2019, 378:686-707). Fang proposes a hybrid PINN to solve PDE, wherein a local fitting method is combined with a neural network to solve PDE (Fang Z. A high-efficient hybrid physics-informed neural networks based on convolutional neural network [J]. IEEE Transactions on Neural Networks and Learning Systems, 2021). The hybrid PINN is used to identify unknown constant parameters in PDE. A generative adversarial network (GAN), proposed by Goodfellow et al., is also physics-based and can solve inverse problems. Stochastic physics-informed GAN is researched to estimate the distribution of unknown parameters in PDE (Goodfellow I, Pouget-Abadie J, Mirza M, et al. Generative adversarial networks [J]. Communications of the ACM, 2020, 63 (11): 139-144). Yang et al. code the controlling physics laws into the architecture of the GAN to solve the inverse problems of stochastic PDE (Yang L, Zhang D, Karniadakis G E. Physics-informed generative adversarial networks for stochastic differential equations [J]. SIAM Journal on Scientific Computing, 2020, 42 (1): A292-A317). Yang et al. also combine the PINN with Bayesian methods to solve the inverse problems in noisy data (Yang L, Meng X, Karniadakis G E. B-PINNs: Bayesian physics-informed neural networks for forward and inverse PDE problems with noisy data [J]. Journal of Computational Physics, 2021, 425:109913).

PDEs can be classified into homogeneous and nonhomogeneous types. A system without external forces can be described by homogeneous partial differential equations. Nonhomogeneous partial differential equations can be used to reveal the continuous energy propagation behavior of a source, so the nonhomogeneous partial differential equations are effective for describing real systems driven by external forces. Yang et al. assume that the functional forms of the solution and the source term are unknown, wherein the measurement of the source term shall be obtained separately from the measurement of the solution. It should be noted that the sparse measurement of the source term and the measurement of the boundary solution are necessary in this research. However, the independent measurement of external forces is not always easy to obtain from practical application (Yang M, Foster J T. Multi-output physics-informed neural networks for forward and inverse PDE problems with uncertainties [J]. Computer Methods in Applied Mechanics and Engineering, 2022:115041). For example, the real distribution of underground seismic wave fields is unknown (S. Karimpouli and P. Tahmasebi, “Physics informed machine learning: Seismic wave equation,” Geoscience Frontiers, vol. 11, no. 6, pp. 1993-2001, 2020). There are a large number of signals inside an engine to represent the operating state of the engine, which cannot be effectively isolated (T. Verhulst, D. Judt, C. Lawson, Y. Chung, O. Al-Tayawe, and G. Ward, “Review for state-of-the-art health monitoring technologies on airframe fuel pumps,” International Journal of Prognostics and Health Management, vol. 13, no. 1, 2022). Gao can directly solve the forward and inverse problems of steady-state PDEs, wherein the source term is assumed to be constant. Therefore, this research is not feasible for unsteady systems with external forces, and shall be described by dynamic functions. (Gao H, Zahr M J, Wang J X. Physics-informed graph neural Galerkin networks: A unified framework for solving PDE-governed forward and inverse problems [J]. Computer Methods in Applied Mechanics and Engineering, 2022, 390:114502.)

The above method has made great progress in the research of the unknown parameters, however, priori information about external forces is not always easy to obtain in practical application. In addition, the existing methods with constant source term assumption cannot be easily extended to describe the spatiotemporal dependence of complex dynamic system behaviors. It is an underinvestigated problem to determine the dynamic source terms with little or no priori information.

### SUMMARY

In view of the existing problems, the present application proposes a coupled physics-informed neural network PINN (C-PINN) method for solving displacement distribution of a bounded vibration string under external driving force using sparse measurement and PDE prior knowledge for describing the displacement distribution of the bounded vibration string. In our method, two neural networks of NetU and NetG are used. The NetU is used to generate the displacement distribution that satisfies the bounded vibration string under the unknown external driving force under the research; and the NetG is used for regularizing the training of NetU. The two networks are then integrated into a data-physics-hybrid loss function. In addition, we propose a hierarchical training strategy to optimize and couple the two networks. Finally, the proposed C-PINN is used for solving the displacement distribution of the bounded vibration string under the unknown external driving force, and verifying the effectiveness of the proposed method by root mean square error (RMSE) of evaluation criterion and the Pearson correlation coefficient (CC).

To achieve the above purpose, the present invention adopts the following technical solution:

A coupled physics-informed neural network for solving displacement distribution of a bounded vibration string under an unknown external driving force comprises the following steps:

The displacement distribution of the bounded vibration string under the unknown external driving force can be described by the following partial differential equation in a general form, i.e., the proposed coupled physics-informed neural network C-PINN is used for solving the following partial differential equation:

$${u}_{t} ( x , t ) + [ u ( x , t ) ] = g ( x , t ) , x ∈ Ω ⊆ {ℝ}^{d} , t ∈ [ 0 , T ] ⊂ ℝ , \qquad ( 1 )$$

That is, x is a spatial variable of the bounded string, t is a vibration time variable and is in an initial state when t=0, uₜ(x, t) is the first-order differential of the displacement with respect to t, u: [symbol] ^{d}× [symbol] → [symbol] is the solution of the equation, i.e., the displacement distribution, and g: [symbol] ^{d}× [symbol] → [symbol] is the source term in a general form, i.e., the external driving force, comprising linear, nonlinear, and steady or dynamic. Q is a spatial open set of the bounded string, and N [.] is a series of partial differential operators, i.e., a series of states of the bounded vibration string changing with time and space.

Equation (1) can be written as the following form of residual function:

$${f}_{N} ( x , t ) := f ( x , t ) - g ( x , t ) = {u}_{t} ( x , t ) + [ u ( x , t ) ] - g ( x , t ) . \qquad ( 2 )$$

When the external driving force g(x, t) is exactly known, \hat{f}_{N}(x, t) obtained by the automatic differentiation of (2) can be directly used for regularizing the approximation of the displacement distribution u(x, t). However, an unknown external driving force g(x, t), that is, when the bounded vibration string is under the unknown external driving force, an unknown f_{N}(x, t) is caused, which makes the form of the above requirement Equation (1) known, that is, the regularization of the known governing equation that requires to describe the system is not feasible.

Therefore, the objective of the coupled physics-informed neural network C-PINN constructed by the present invention is to approximate the displacement distribution of the bounded vibration string under the unknown external driving force, that is, to solve the partial differential equation with an unknown source term described in equation (1). Thus, the proposed C-PINN comprises two neural networks: NetU and NetG, wherein: (a) Neil/is used for approximating the solution that satisfies equation (1); and (b) NetG is used for regularizing the training of NetU.

Step 1: constructing a loss function for training C-PINN.

To train the C-PINN, a training set is obtained by uniform random sampling from the bounded vibration string under the unknown external driving force. The training set is obtained for sampling. Wherein a training dataset is represented by D, D is composed of boundary and initial training data D_{B} and internal training data D_{I}, and D_{B} ∩D_{I}=Ø. E represents a set (x, t) of collocation points corresponding to (x, t, u)∈D_{I}. A data-physics-hybrid loss function shown in formula (3) is used for training the C-PINN.

$$MSE = M S {E}_{D} + M S {E}_{P N} \qquad ( 3 )$$

wherein MSE_{D} and MSE_{PN} represent the data-driven loss and the physics-informed loss of a given equation (1), respectively, which is a general nonhomogeneous partial differential equation. Wherein MSE_{D} is obtained from the following equation.

$$M S {E}_{D} = {\sum }_{( x , t , u ) ∈ D} ( \hat{u } {( x , t ; {\hat{Θ}}_{U} - u ( x , t ) )}^{2} \qquad ( 4 )$$

û(x, t; \hat{Θ}_{U}) is a function of the network NetU whose training parameter set is Θ_{U}.
MSE_{PN} is obtained from the following equation.

$$M S {E}_{P N} = {{Σ}_{( x , t ) ∈ E} ( \hat{f} ( x , t ) - \hat{g} ( x , t ; {\hat{Θ}}_{G} ) )}^{2} \qquad ( 5 )$$

ĝ(x, t; \hat{Θ}G) is a function of the network NetG whose training parameter set is Θ_{G}. \hat{f}(x, t):=ûₜ(û(x, t))+ [symbol] (û(x, t) is the approximation of the network NetU to g. MSE_{PN} corresponds to the physics-informed loss of (2) on (1) of the nonhomogeneous partial differential equation on a finite set (x, t)∈E of collocation points, used to regularize u in NetU to satisfy equation (1).

Step 2: optimizing and coupling the proposed C-PINN by a hierarchical training strategy to predict the displacement of the bounded vibration string under the external driving force over time at any position, i.e., solve equation (2) to obtain the predicted value û(x, t) at any point (x, t).

Considering the relation between the network NetU and the network NetG in the loss function MSE in equation (3), the hierarchical training strategy is proposed. In practical application of vibration of the bounded string, it is difficult to obtain the specific form of the external driving force, even the sparse measurements cannot be obtained, that is, the exact expression of g(x, t) in equation (1) cannot even be obtained by sparse measurements. However, the sparse displacement distribution of the bounded string driven by an external force can be collected by using a displacement sensor in the position where it is convenient to install the displacement sensor inside the bounded string, i.e., the obtained sparse measurement data D_{I} within a region is applied to regularize the structure of PDEs to obtain \hat{Θ}_{G}. Therefore, Θ_{U} and Θ_{G} should be iteratively estimated with mutual dependence. Assuming k as the number of steps of the present iteration, the core problem of the hierarchical training strategy can be described by the following two optimization problems.

$${\hat{Θ}}_{G}^{( k + 1 )} = {arg min}_{{Θ}_{G}} \{ M S {E}_{D} ( {\hat{Θ}}_{U}^{( k )} ) + M S {E}_{P N} ( {Θ}_{G} ; {\hat{Θ}}_{U}^{( k )} ) \} = {arg min}_{{Θ}_{G}} {MSE}_{P N} ( {Θ}_{G} ; {\hat{Θ}}_{U}^{( k )} ) \qquad ( 6 )$$

$$and$$

$${\hat{Θ}}_{U}^{( k + 1 )} = {arg min}_{{Θ}_{U}} \{ M S {E}_{D} ( {Θ}_{U} ) + M S {E}_{P N} ( {Θ}_{U} ; {\hat{Θ}}_{G}^{( k + 1 )} ) \} , \qquad ( 7 )$$

\hat{Θ}_{U}^{(k)} is a parameter set estimated by the network NetU at step k, \hat{Θ}_{G}^{(k+1)} is a parameter set estimated by the network NetG at step k+1, and \hat{Θ}_{G}^{(k+1)} is used for describing the function û(x, t; \hat{Θ}_{U}^{(k+1)}).

Based on the two core optimization problems of the above hierarchical training strategy, algorithm 1 is used for specifically describing the specific details of the hierarchical strategy:

Algorithm 1 Hierarchical optimization coupling strategy of C-PINN:
Initialization: training data (x, t, u)∈D and collocation point (x, t)∈E are randomly sampled in a bounded string vibration system. The initialization parameter sets Θ_{U}⁽⁰⁾ and Θ_{G}⁽⁰⁾ of the network NetU and the network NetG are randomly generated.
Step 0: assuming that the k-step iteration has obtained the parameter sets Θ_{U}^{(k)} and Θ_{G}^{(k)}.

The following steps are repeated:
Stepk-1: obtaining \hat{Θ}_{U}^{(k+1)} by solving the optimization problem (6), where ûₜ(x, t; \hat{Θ}_{U}^{(k)})+ [symbol] (û(x, t; \hat{Θ}_{U}^{(k)}) in MSE_{PN} comes from the iterative result \hat{Θ}_{U}^{(k)} of the previous step.
Stepk-2: obtaining \hat{Θ}_{U}^{(k+1)} by solving the optimization problem (7), and using \hat{Θ}_{U}^{(k+1)} for predicting ĝ(x, t; Θ_{G}^{(k+1)}) in MSE_{PN}.
Until stop criteria are satisfied, reaching a specified number of iterations or reaching error accuracy.
Returning \hat{Θ}_{U}→û(x, t; \hat{Θ}_{U}) for predicting a predicted value û(x, t) for any point (x, t) in Ω in equation (2).

It is noted that Θ_{U}⁽⁰⁾ and Θ_{G}⁽⁰⁾ are used for initialization of the given parameter set of the NetU and the parameter set of the NetG at -Step 0 respectively. In addition, the iterative transmission of the NetG and NetU parameter sets is also conducted in the algorithm.

Step 3: Evaluate the performance of the proposed C-PINN method in solving the displacement distribution of the bounded vibration string under the unknown external driving force, that is, the performance solving equation (1) with an unknown source term using the proposed C-PINN.

Root mean squared error (RMSE) is used

$$R M S E = \sqrt{\frac{1}{\vert T \vert} {\sum }_{( x , t ) ∈ T} {( u ( x , t ) - \hat{u} ( x , t ) )}^{2}} \qquad ( 8 )$$

for evaluating the performance of the proposed C-PINN method in predicting the displacement distribution of the bounded vibration string under the unknown external driving force. |T| is a cardinality of a test set (x, t)∈T of collocation points; and u(x, t) and û(x, t) represent an actual displacement distribution value and a corresponding predicted displacement distribution value respectively. RMSE of the test set and RMSE of a snapshot map are calculated to evaluate the performance of the proposed C-PINN in solving the displacement distribution of the bounded vibration string under the unknown external driving force. The closer the value of RMSE is to 0, the better the performance of the proposed C-PINN is.

To further verify the performance of the C-PINN, the Pearson correlation coefficient is used:

$$CC = \frac{cov ( u ( x , t ) , \hat{u} ( x , t ) )}{\sqrt{Var u ( x , t )} \sqrt{Var \hat{u} ( x , t )}} \qquad ( 9 )$$

The similarity between the actual displacement distribution value and the predicted displacement distribution value is calculated. CC is the correlation coefficient of u(x, t) and <û(x, t), and cov (u(x, t), û(x, t)) is the covariance of u(x, t) and û(x, t). Var u(x, t) and

$$\sqrt{Var \hat{u} ( x , t )}$$

are variances of u(x, t) and û(x, t) respectively. Similar to RMSE, the performance of C-PINN in solving the predicted displacement distribution of the bounded vibration string under the unknown external driving force is evaluated by calculating CC of the test set and CC of the snapshot map. The closer the value of CC is to 1, the better the performance of the proposed C-PINN is.

The generality is not lost. Multiple types of dynamic systems with spatiotemporal dependence under external driving can be described by equation (1), and in addition to the displacement distribution of the bounded vibration string under the external driving force, also comprises: (a) a heat diffusion system, which is described by the heat equation of the temperature distribution inside the bounded string. The heat flows inside the bounded string and introduces an external heat source when the temperature distribution in the bounded string is not uniform. For example, the amount of the heat source generated inside an aero-engine in the actual operation process cannot be measured, which is need to solve the heat equation with an unknown external heat source in order to obtain the temperature distribution at any point; and (b) 3-D Helmholtz equation: which describes the distribution of electromagnetic waves under the influence of the external source. If there is an electromagnetic influence between component levels in the operation process of the aero-engine and an external electromagnetic source of an object under study cannot be obtained, in order to obtain the electromagnetic wave distribution of any point of the object under study, the Helmholtz equation under an unknown external electromagnetic source is solved.

The present invention has the beneficial effects: the present invention proposes a novel PINN, called C-PINN, used for solving the displacement distribution of the bounded vibration string under an external driving force with little or even no priori information. The present invention comprises two neural networks: NetU and NetG. NetU is used for approximating satisfying the displacement distribution of the bounded vibration string under study. The NetG is used for regularizing u to satisfy the displacement distribution of the approximation of NetU. The two networks are then integrated into a data-physics-hybrid loss function. In addition, the proposed hierarchical training strategy is used for optimizing the loss function and realizing the coupling of the two networks. Finally, RMSE and CC are used for verifying the performance of C-PINN in solving the displacement distribution of the bounded vibration string under the external driving force, and the results are close to 0 and close to 1 respectively, which indicates that C-PINN has good performance in solving the displacement distribution of the bounded vibration string under the external driving force with little or no priori information. Moreover, the proposed C-PINN is suitable for solving multiple types of dynamic systems with spatiotemporal dependence under the external driving, including solving the temperature distribution under the external heat source, the electromagnetic distribution of electromagnetic waves under external influence, etc.

### DESCRIPTION OF DRAWINGS

FIG. 1 is an architecture diagram of C-PINN;

FIG. 2 is a heat map of a predicted value û(x, t) of a 1-D wave equation for describing displacement distribution of a 1-D bounded vibration string;

FIG. 3 shows predicted values and actual values corresponding to a snapshot map at t=1.5 in FIG. 2;

FIG. 4 shows predicted values and actual values corresponding to a snapshot map at t=3 in FIG. 2;

FIG. 5 shows predicted values and actual values corresponding to a snapshot map at t=4.5 in FIG. 2;

FIG. 6 is a heat map of a predicted value û(x, t) of a 1-D heat diffusion equation with Dirichlet boundary conditions for describing temperature distribution of a 1-D bounded string with adiabatic ends at both ends;

FIG. 7 shows predicted values and actual values corresponding to a snapshot map at t=1.5 in FIG. 6;

FIG. 8 shows predicted values and actual values corresponding to a snapshot map at t=3 in FIG. 6;

FIG. 9 shows predicted values and actual values corresponding to a snapshot map at t=4.5 in FIG. 6;

FIG. 10 is a heat map of a predicted value û(x, t) of a 1-D heat diffusion equation with Neumann boundary conditions for describing temperature distribution of a 1-D bounded string with an adiabatic end at one end and a heat dissipation end at the other end;

FIG. 11 shows predicted values and actual values corresponding to a snapshot map at t=3 in FIG. 10;

FIG. 12 shows predicted values and actual values corresponding to a snapshot map at t=6 in FIG. 10;

FIG. 13 shows predicted values and actual values corresponding to a snapshot map at t=9 in FIG. 10;

FIG. 14 is a heat map of a predicted value u(x, y) of a 2-D Poisson equation for describing temperature distribution of a sheet;

FIG. 15 shows predicted values and actual values corresponding to a snapshot map at y=0.2 in FIG. 14;

FIG. 16 shows predicted values and actual values corresponding to a snapshot map at y=0.4 in FIG. 14;

FIG. 17 shows predicted values and actual values corresponding to a snapshot map at y=0.6 in FIG. 14;

FIG. 18 is a heat map of a snapshot map û(x, y, z=0.12) of a 3-D Helmholtz equation (x, y, z=0.12) for describing spatial distribution of electromagnetic waves;

FIG. 19 shows predicted values and actual values corresponding to a snapshot map (x=0.05 and z=0.12) in FIG. 18;

FIG. 20 shows predicted values and actual values corresponding to a snapshot map (x=0.15 and z=0.12) in FIG. 18;

FIG. 21 shows predicted values and actual values corresponding to a snapshot map (x=0.2 and z=0.12) in FIG. 18.

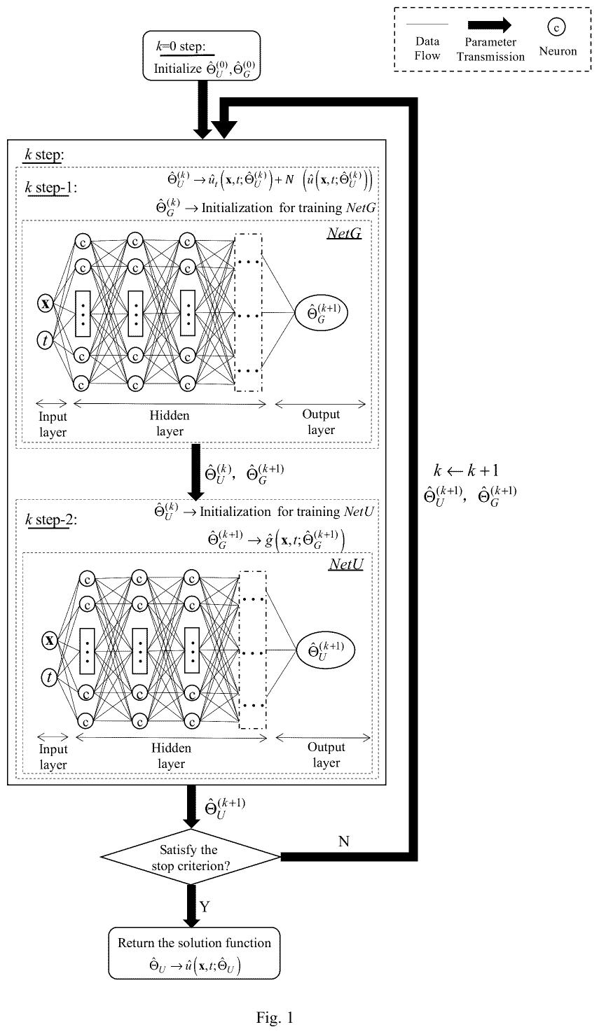

### DETAILED DESCRIPTION

The present invention provides a coupled physics-informed neural network for solving a partial differential equation with an unknown source term. Specific embodiments discussed are only used for illustrating the implementation mode of the present invention, not used for limiting the scope of the present invention. The implementation mode of the present invention is described below in detail in conjunction with the drawings, specifically comprising the following steps:

Embodiment 1 The displacement distribution that describes a bounded 1-D vibration string under an external driving force is solved, that is, a 1-D wave partial differential equation with the following general form is solved.

$$\frac{{\partial }^{2} u}{\partial {t}^{2}} = {a}^{2} \frac{{\partial }^{2} u}{\partial {x}^{2}} + g ( x , t ) , 0 < x < L , t > 0 \qquad ( 10 )$$

$$u {\vert}_{x = 0} = 0 , u {\vert}_{x = L} = 0 , t > 0$$

$$u {\vert}_{t = 0} = 0 , \frac{\partial u}{\partial t} {\vert}_{t = 0} = 0 , 0 \leq x \leq L ,$$

In the bounded string, vibration wave speed a=1, the length L=π and the vibration wave propagation time t=6. The external driving force at the bounded string (x, t) region is displacement is

$$u ( x , t ) = \frac{L}{4 a π} ( \frac{L}{2 a π} - t cos \frac{2 a π}{L} t ) sin \frac{2 π}{L} x$$

The wave equation that represents the displacement distribution of the 1-D bounded vibration string is converted to PDE in the residual form of equation (2)

$${f}_{s} ( x , t ) = \frac{{\partial }^{2} u}{\partial {t}^{2}} - {a}^{2} \frac{{\partial }^{2} u}{\partial {x}^{2}} - g ( x , t ) \qquad ( 11 )$$

Therefore, the objective of the coupled physics-informed neural network C-PINN constructed by the present embodiment is to approximate the displacement distribution of the bounded vibration string under the unknown external driving force, that is, to solve the 1-D wave partial differential equation with an unknown source term described in (10). Thus, C-PINN comprises two neural networks: NetU and NetG, wherein: (a) NetU is used for approximating the solution that satisfies (10), i.e., for solving the displacement distribution of the 1-D bounded vibration string under the external driving force; and (b) NetG is used for regularizing the training of NetU.

### 1. Construction of Loss Function.

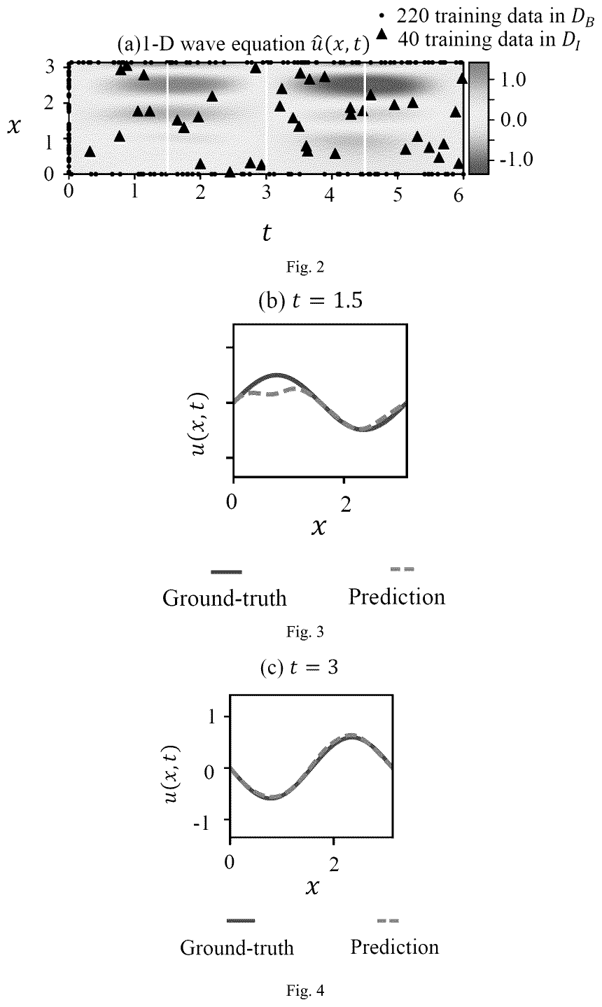

A training set is obtained from a uniform random sampling of a 1-D bounded string vibration system controlled by the 1-D wave equation expressed by equation (10). In the present embodiment, a training set containing 210 training samples is obtained from random uniform sampling in region [0, 1]×[0,6], including 120 training data that satisfy boundary conditions and 50 training data that satisfy initial conditions, and 40 internal training data (x, t, u)∈D_{I} and collocation point (x, t)∈E collocation point are acquired. The training set is shown in FIG. 2. The structure of equation (10) is guaranteed by the collocation point. C-PINN is trained by the loss function as shown in equation (3). MSE_{D} and MSE_{PN} represent the data-driven loss and the physics-informed loss of equation (10) respectively. Wherein MSE_{D} is obtained by equation (4), and û(x, t; \hat{Θ}_{U}) is a function of the network NetU whose training parameter set is \hat{Θ}U. The MSE_{PN} is obtained by equation (5), and § (x, t; \hat{Θ}_{G}) is a function of the network NetG whose training parameter set is \hat{Θ}_{G}. \hat{f}(x, t): =ûₜ(û(x, t))+ [symbol] (û(x, t) is the approximation of the network NetU to an unknown external driving force g. The MSE_{PN} corresponds to the physics-informed loss of (11) on (10) of the finite set (x, t)∈ E of collocation points, used to regularize u in the network NetU to satisfy equation (10).

### 2. Hierarchical Training Strategy.

Considering the relation between the network NetU and the network NetG in the loss function MSE, the hierarchical training strategy is proposed. In many cases of practical application, the exact expression of the external driving force ĝ(x, t) cannot be obtained even by sparse measurements. However, the obtained sparse measurement data D_{I} within a region can be applied to regularize the structure of (10) to obtain \hat{Θ}_{G}.

Therefore, Θ_{U} and Θ_{G} are mutual dependence and are estimated through iteration estimation. Assuming k as the number of steps of the present iteration, the core problem of the hierarchical training strategy can be described by two optimization problems (6) and (7).

\hat{Θ}_{U}^{(k)} is a parameter set estimated by the network NetU at step k, \hat{Θ}_{G}^{(k+1)} is a parameter set estimated by the network NetG at step k+1, and 0 is used for describing the function û(x, t; \hat{Θ}_{U}^{(k+1)}). The details obtained by a mutual iteration strategy can be described by algorithm 1:

### Algorithm 1: Hierarchical Optimization Coupling Strategy of C-PINN

Initialization: training data (x, t, u)∈D and collocation point (x, t)∈E are randomly sampled. The initialization parameter sets Θ_{U}⁽⁰⁾ and Θ_{G}⁽⁰⁾ of the network NetU and the network NetG are randomly generated, respectively.
Step 0: assuming that the k-step iteration has obtained the parameter sets Θ_{U}^{(k)} and Θ_{G}^{(k)}.

The following steps are repeated:
Stepk-1: obtaining \hat{Θ}_{G}^{(k+1)} by solving the optimization problem (6), where ûₜ(x, t; \hat{Θ}_{U}^{(k)})+ [symbol] (û(x, t; \hat{Θ}_{U}^{(k)}) in MSE_{PN} comes from the iterative result \hat{Θ}_{U}^{(k)} of the previous step.
Stepk-2: obtaining \hat{Θ}_{U}^{(k+1)} by solving the optimization problem (7), and using \hat{Θ}_{U}^{(k+1)} for predicting ĝ(x, t; Θ_{U}^{(k+1)}) in MSE_{PN}
Until stop criteria are satisfied, reaching a specified number of iterations or reaching error accuracy.
Returning \hat{Θ}_{U}→û(x, t; \hat{Θ}_{U}) for predicting a predicted value û(x, t) for any point (x, t) in Ω in equation (11).

It is noted that Θ_{U}⁽⁰⁾ and Θ_{G}⁽⁰⁾ are used for initialization of the given parameter set of the NetU and the parameter set of the NetG at step 1, respectively. In addition, the iterative transmission of the NetG and NetU parameter sets is also conducted in the algorithm.

Step 4: evaluating the performance of the proposed C-PINN method in solving the displacement distribution of the 1-D bounded vibration string under the unknown external driving force by (8), i.e., solving the performance under the 1-D wave equation with the unknown source term. u(x, t) and û(x, t) represent an actual displacement distribution value and a corresponding predicted displacement distribution value, respectively. RMSE=7.068626e-02, which can obtain a prediction error close to 0, and the prediction performance is good.

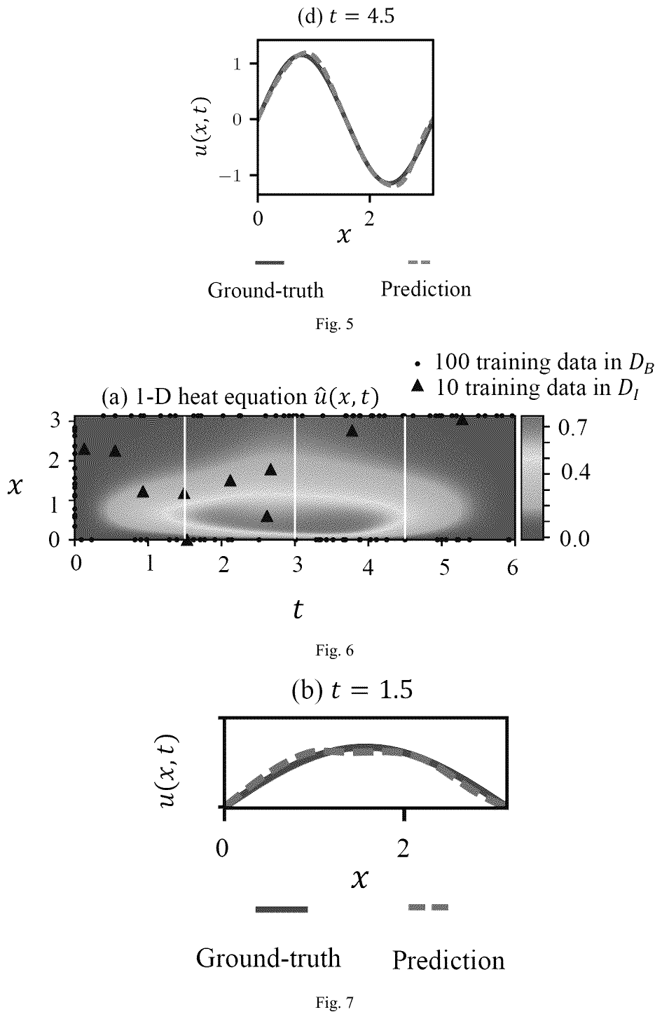

To further verify the performance of the C-PINN, the Pearson correlation coefficient equation (9) is further used. In the present embodiment, the similarity between the actual displacement distribution value and the corresponding predicted displacement distribution value is 9.864411e-01, and the correlation is high. In the present embodiment, the relevant setting for C-PINN is that the number of hidden layers is 3 and each layer has 30 neurons. The scale of prediction is shown in FIG. 2, and the comparison between the predicted and actual values of the snapshot maps at 1=1.5, 3, and 4.5 is shown in FIG. 3-FIG. 5 respectively.

The evaluation criteria of prediction performance at (=1.5, 3, and 4.5 are shown in Table 1

TABLE 1
Evaluation Criteria for Three Time Snapshots
Shown by Dotted Lines in FIG. 2

| Evaluation Criteria | 1.5 | 3 | 4.5 |
|---|---|---|---|
| RMSE | 1.424030e−02 | 3.305190e−02 | 5.201132e−02 |
| CC | 9.6238994e−01 | 9.985312e−01 | 9.983170e−01 |

It can be seen from Table 1 that RMSE is close to 0 and CC is close to 1, and C-PINN has good performance in solving the displacement distribution of the 1-D bounded string with the unknown external driving force.

The generality is not lost. Multiple types of dynamic systems with spatiotemporal dependence under external driving can be described by equation (1), and in addition to the displacement distribution of the bounded vibration string under the external driving force, also comprises: (a) a heat diffusion system: which is described by the heat equation of the temperature distribution inside the bounded string. The heat flows inside the bounded string and introduces an external heat source when the temperature distribution in the bounded string is not uniform. For example, the amount of the heat source generated inside an aero-engine in the actual operation process cannot be measured, which is need to solve the heat equation with an unknown external heat source in order to obtain the temperature distribution at any point; and (b) a 3-D Helmholtz equation: which describes the distribution of electromagnetic waves under the influence of the external source. If there is an electromagnetic influence between component levels in the operation process of the aero-engine and an external electromagnetic source of an object under study cannot be obtained, in order to obtain the electromagnetic wave distribution of any point of the object under study, the Helmholtz equation under an unknown external electromagnetic source is solved.

Embodiment 2 The temperature distribution of the 1-D bounded string under unknown external heat sources with adiabatic ends on both sides is solved, that is, the 1-D heat diffusion equation with an unknown external source term having Dirichlet boundary conditions is solved:

$$\frac{\partial u}{\partial t} = {a}^{2} \frac{{\partial }^{2} u}{\partial {x}^{2}} + g ( x , t ) , 0 < x < L , t > 0 \qquad ( 12 )$$

$$u {\vert}_{t = 0} = ϕ ( x ) , 0 \leq x \leq L$$

$$u {\vert}_{x = 0} = 0 , u {\vert}_{x = L} = 0 , t > 0$$

Thermal diffusivity a=1, u(x, t) is the temperature at any (x, t), the length of the bounded string L=T, the initial temperature ϕ(x)=0 and g(x, t) is an external unknown heat source. The analytical expression of temperature distribution is

$$u ( x , t ) = 2 t {e}^{- t} sin x + 2 ( {e}^{t} - 1 ) {\sum }_{n = 2}^{∞} \frac{{( - 1 )}^{n + 1}}{n ( {n}^{2} - 1 )} {e}^{- {n}^{2} t} sin nx$$

PDE in the residual form is obtained

$${f}_{s} ( x , t ) = \frac{\partial u}{\partial t} - {a}^{2} \frac{{\partial }^{2} u}{\partial {x}^{2}} - g ( x , t ) \qquad ( 13 )$$

The objective of the coupled physics-informed neural network C-PINN constructed by the present embodiment is to approximate the temperature distribution of the bounded string under the unknown external heat source, that is, to solve the 1-D heat diffusion partial differential equation with an unknown source term described in (12). Thus, C-PINN comprises two neural networks: NetU and NetG, wherein: (a) NetU is used for approximating the solution that satisfies (12), i.e., for solving the temperature distribution of the 1-D bounded string under the external heat source; and (b) NetG is used for regularizing the training of NetU.

### 1. Construction of Loss Function:

A training set is obtained from a uniform random sampling of the bounded string with adiabatic ends and an unknown external heat source controlled by a systematic equation (12). In the present embodiment, the training set is obtained from random uniform sampling in [0,π]×[0,6], including 110 boundary and initial training data (x, t, u)∈D_{B} and 10 internal training data (x, t, u)∈D_{I}, and D_{B}∩D_{I}=Φ. 10 collocation points (x, t)∈E collocate a point set, and the training set is shown in FIG. 6. The structure of PDE is guaranteed by the collocation points. The proposed C-PINN is trained by the loss function in (3). MSE_{D} and MSE_{PN} represent the data-driven loss and the physics-informed loss of the given equation (12) respectively. Wherein MSE_{D} is obtained by equation (4), and û(x, t; \hat{Θ}_{U}) is a function of the network NetU whose training parameter set is \hat{Θ}_{U}. The MSE_{PN} is obtained by equation (5), and g (x, t; \hat{Θ}_{G}) is a function of the network NetG whose training parameter set is \hat{Θ}_{G}. \hat{f}(x, t):=ûₜ(û(x, t))+ [symbol] (û(x, t) is the approximation of the network NetU to g. The MSE_{PN} corresponds to the physics-informed loss of (13) on (12) of the finite set (x, t)∈E of collocation points, used to regularize u in the network NetU to satisfy equation (12).

### 2. Hierarchical Training Strategy.

Considering the relation between the network NetU and the network NetG in the loss function MSE, the hierarchical training strategy is proposed. In many cases of practical application, for example, the exact expression of the external heat source g(x, t) inside an engine cannot be obtained even by sparse measurements. However, the obtained sparse measurement data D_{I} within a region can be applied to regularize the structure of (12) to obtain \hat{Θ}_{G}.

Therefore, Θ_{U} and Θ_{G} mutual dependence and are estimated through iteration estimation. Assuming k as the number of steps of the present iteration, the core problem of the hierarchical training strategy can be described by the following two optimization problems (6) and (7).

\hat{Θ}_{U}^{(k)} is a parameter set estimated by the network NetU at step k, \hat{Θ}_{G}^{(k+1)} is a parameter set estimated by the network NetG at step k+1, and \hat{Θ}_{G}^{(k+1)} is used for describing the function û(x, t; \hat{Θ}_{U}^{(k+1)}). The details obtained by a mutual iteration strategy can be described by algorithm 1:

### Algorithm 1: Hierarchical Optimization Coupling Strategy of C-PINN

Initialization: training data (x, t, u)∈D and collocation point (x, t)∈E are randomly sampled. The initialization parameter sets Θ_{U}⁽⁰⁾ and Θ_{G}⁽⁰⁾ of the network NetU and the network NetG are randomly generated, respectively.
Step 0: assuming that the k-step iteration has obtained the parameter sets Θ_{U}^{(k)} and Θ_{G}^{(k)}.

The following steps are repeated:
Stepk-1: obtaining \hat{Θ}_{G}^{(k+1)} by solving the optimization problem (6), where ûₜ(x, t; \hat{Θ}_{U}^{(k)})+ [symbol] (û(x, t; \hat{Θ}_{U}^{(k)}) in MSE_{PN} comes from the iterative result \hat{Θ}_{U}^{(k)} of the previous step.
Stepk-2: obtaining \hat{Θ}_{U}^{(k+1)} by solving the optimization problem (7), and using \hat{Θ}_{U}^{(k+1)} for predicting ĝ(x, t; Θ_{U}^{(k+1)}) in MSE_{PN}
Until stop criteria are satisfied, reaching a specified number of iterations or reaching error accuracy.
Returning \hat{Θ}_{U}→û(x, t; \hat{Θ}_{U}) for predicting a predicted value û(x, t) for any point (x, t) in Ω in equation (13).

It is noted that Θ_{U}⁽⁰⁾ and Θ_{G}⁽⁰⁾ are used for initialization of the given parameter set of the NetU and the parameter set of the NetG at step 1, respectively. In addition, the iterative transmission of the NetG and NetU parameter sets is also conducted in the algorithm.

### 3. Evaluation of Performance

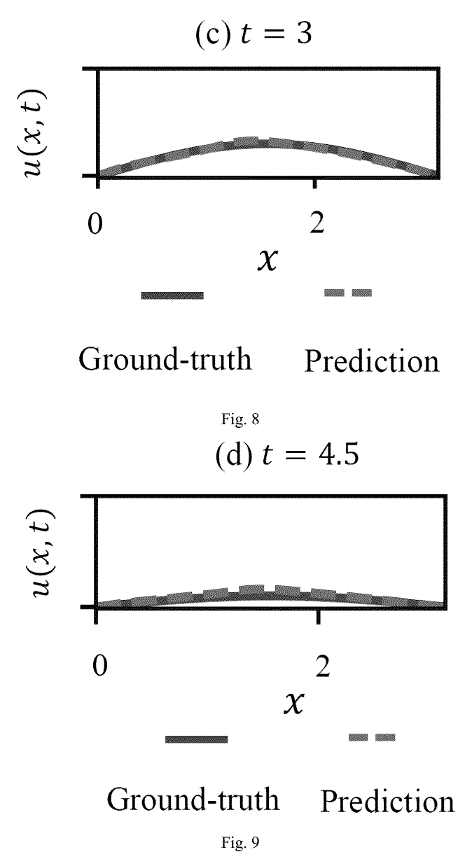

The performance of the proposed C-PINN method in solving the 1-D heat diffusion equation with Dirichlet boundary conditions and unknown source terms is evaluated by RMSE of equation (8), and RMSE=4.225390e-02. To further verify the performance of the C-PINN, the Pearson correlation coefficient equation (9) is further used. In the present embodiment, the similarity between an actual temperature distribution value and a corresponding predicted temperature distribution value is 9.785444e-01, and the correlation is high. In the present embodiment, the relevant setting for the proposed C-PINN is that the number of hidden layers is 10 and each layer has 20 neurons. The scale of prediction is shown in FIG. 6, and the comparison between the predicted and actual values of the snapshot maps at t=1.5, 3 and 4.5 is shown in FIG. 7-FIG. 9 respectively.

The evaluation criteria of prediction performance at t=1.5, 3, and 4.5 are shown in Table 2.

TABLE 2
Evaluation Criteria for Three Time Snapshots
Shown by Dotted Lines in FIG. 6

| Evaluation criteria | 1.5 | 3 | 4.5 |
|---|---|---|---|
| RMSE | 4.600305e−02 | 1.342719e−02 | 2.991229e−02 |
| CC | 9.753408e−01 | 9.912983e−01 | 9.805664e−01 |

It can be seen from Table 2 that RMSE is close to 0 and CC is close to 1, and the proposed C-PINN has good performance in solving the temperature distribution of the 1-D bounded string with the unknown external heat source.

Embodiment 3 The temperature distribution of the 1-D bounded string under unknown external heat sources with an adiabatic end on one end and a heat dissipation end at the other end is solved, that is, the 1-D heat diffusion equation with an unknown external source term having Neumann boundary conditions is solved:

Two neural networks: NetU and NetG of the proposed C-PINN are constructed for solving the following partial differential equation in the general form. To illustrate that the proposed C-PINN does not lose generality, the 1-D heat diffusion equation having Neumann boundary conditions with the unknown external source is taken as an example.

$$\frac{\partial u}{\partial t} = {a}^{2} \frac{{\partial }^{2} u}{\partial {x}^{2}} + g ( x , t ) , 0 < x < L , t > 0 \qquad ( 14 )$$

$$u {\vert}_{t = 0} = ϕ ( x ) , 0 \leq x \leq L$$

$$u {\vert}_{x = 0} = 0 , \frac{\partial u}{\partial x} {\vert}_{x = L} = 0 , t > 0$$

Thermal diffusivity a=1, u(x, t) is the temperature at any (x, t) position, the length of the bounded string L=T, the initial temperature

$$ϕ ( x ) = sin \frac{x}{2} and g ( x , t ) = sin \frac{x}{2}$$

is an external unknown heat source. The analytical expression of temperature distribution is

$$u ( x , t ) = ( 4 - 3 {e}^{- \frac{t}{4}} ) sin \frac{x}{2} .$$

PDE in the residual form is obtained

$${f}_{s} ( x , t ) = \frac{\partial u}{\partial t} - {a}^{2} \frac{{\partial }^{2} u}{\partial {x}^{2}} - g ( x , t ) \qquad ( 15 )$$

Thus, the proposed C-PINN comprises two neural networks: NetU and NetG, wherein: (a) NetU is used for approximating the solution that satisfies (14), i.e., for solving the displacement distribution of the 1-D bounded vibration string under the external driving force; and (b) NetG is used for regularizing the training of NetU.

### 1. Construction of Loss Function:

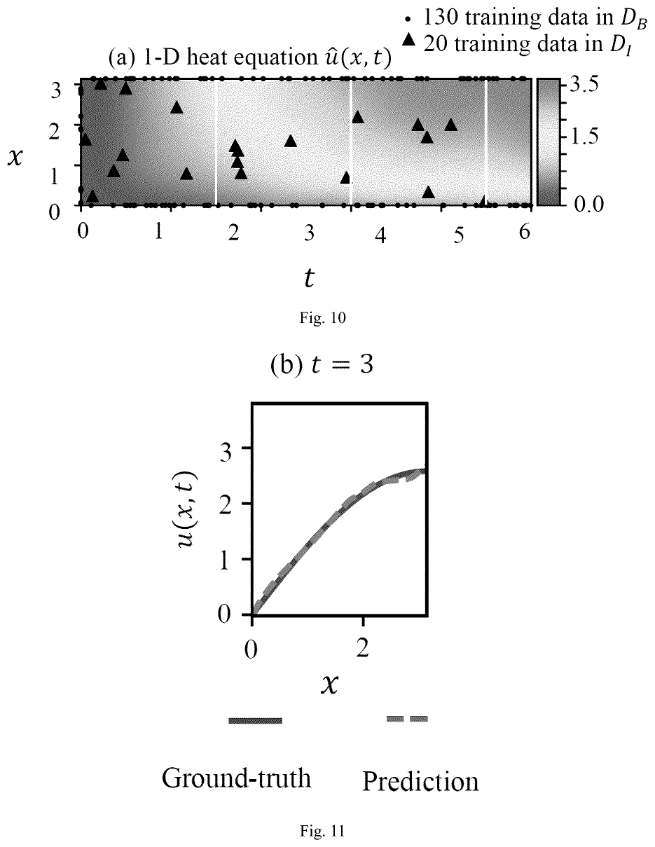

A training set is obtained from uniform random sampling in a system controlled by equation (14). In the present embodiment, the training set is obtained from random uniform sampling in [0,π]×[0,10], and includes 130 boundary and initial training data (x, t, u)∈D_{B}, including 10 initial condition training data, 60 left boundary condition training data and 60 right boundary condition training data, and 20 internal training data (x, t, u) E D_{I}. 20 collocation points (x, t)∈E, and the training set is shown in FIG. 10. The structure of equation (14) is guaranteed by the collocation points. The proposed C-PINN is trained by the loss function in equation (3). MSE_{D} and MSE_{PN} represent the data-driven loss and the physics-informed loss of the given equation (14), respectively. Wherein MSE_{D} is obtained by equation (5), and û(x, t; Θ_{U}) is a function of the network NetU whose training parameter set is Θ_{U}. MSE_{PN} is obtained by equation (6), and ĝ(x, t; Θ_{G}) is a function of the network NetG whose training parameter set is Θ_{G}. \hat{f}(x, t): =ûₜ(û(x, t))+ [symbol] (û(x, t) is the approximation of the network NetU to g. MSE_{PN} corresponds to the physics-informed loss of (15) on the finite set (x, t)∈E of collocation points (14), used to regularize u in the network NetU to satisfy equation (14).

### 2. Hierarchical Training Strategy.

Considering the relation between the network NetU and the network NetG in the loss function MSE, the hierarchical training strategy is proposed. In many cases of practical application, for example, the exact expression of the external heat source g(x, t) inside an engine cannot be obtained even by sparse measurements. However, the obtained sparse measurement data D_{I} within a region can be applied to regularize the structure of (14) to obtain \hat{Θ}_{G}.

Therefore, Θ_{U} and Θ_{G} are mutual dependence and are estimated through iteration estimation. Assuming k as the number of steps of the present iteration, the core problem of the hierarchical training strategy can be described by two optimization problems (6) and (7).

\hat{Θ}_{U}^{(k)} is a parameter set estimated by the network NetU at step k, \hat{Θ}_{G}^{(k+1)} is a parameter set estimated by the network NetG at step k+1, and \hat{Θ}_{G}^{(k+1)} is used for describing the function û(x, t; \hat{Θ}_{U}^{(k+1)}). The details of the mutual iteration strategy can be described by algorithm 1:

### Algorithm 1: Hierarchical Optimization Coupling Strategy of C-PINN

Initialization: training data (x, t, u)∈D and collocation point (x, t)∈E are randomly sampled. The initialization parameter sets Θ_{U}⁽⁰⁾ and Θ_{G}⁽⁰⁾ of the network NetU and the network NetG are randomly generated, respectively.
Step 0: assuming that the k-step iteration has obtained the parameter sets Θ_{U}^{(k)} and Θ_{G}^{(k)}.

The following steps are repeated:
Stepk-1: obtaining \hat{Θ}_{G}^{(k+1)} by solving the optimization problem (6), where ûₜ(x, t; \hat{Θ}_{U}^{(k)})+ [symbol] (û(x, t; \hat{Θ}_{U}^{(k)}) in MSE_{PN} comes from the iterative result \hat{Θ}_{U}^{(k)} of the previous step.
Stepk-2: obtaining \hat{Θ}_{U}^{(k+1)} by solving the optimization problem (7), and using \hat{Θ}_{U}^{(k+1)} for predicting ĝ(x, t; Θ_{U}^{(k+1)}) in MSE_{PN}
Until stop criteria are satisfied, reaching a specified number of iterations or reaching error accuracy.
Returning \hat{Θ}_{U}→û(x, t; \hat{Θ}_{U}) for predicting a predicted value û(x, t) for any point (x, t) in Ω in equation (15).

It is noted that Θ_{U}⁽⁰⁾ and Θ_{G}⁽⁰⁾ are used for initialization of the given parameter set of the NetU and the parameter set of the NetG at step 1, respectively. In addition, the iterative transmission of the NetG and NetU parameter sets is also conducted in the algorithm.

### 3. Evaluation of Performance

RMSE of equation (8) is used for evaluating the performance of the proposed C-PINN method in solving the temperature distribution of the 1-D bounded string under unknown external heat sources with an adiabatic end on one end and a heat dissipation end at the other end, that is, solving the 1-D heat diffusion equation with an unknown external source term having Neumann boundary conditions. RMSE=5.748950e-02. u(x, t) and û(x, t) represent an actual temperature value and a corresponding predicted temperature value, respectively. To further verify the performance of the C-PINN, (9) CC-9.988286e-01 is used for further illustrating that the proposed C-PINN method has good performance in solving the temperature distribution of the 1-D bounded string under unknown external heat sources with an adiabatic end on one end and a heat dissipation end at the other end, that is, solving the 1-D heat diffusion equation with the unknown external source term having Neumann boundary conditions.

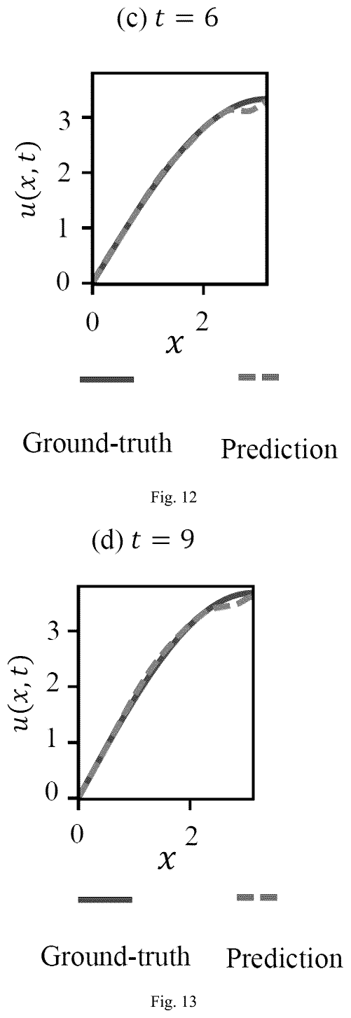

In the present embodiment, the relevant setting for the proposed C-PINN is that the number of hidden layers is 3 and each layer has 30 neurons. The scale of prediction is shown in FIG. 10, and the specific comparison between the predicted and actual values of the snapshot maps at t=3, 6, and 9 is shown in FIG. 11-FIG. 13, respectively.

The evaluation criteria of prediction performance at t=3, 6, and 9 are shown in Table 3.

TABLE 3
Evaluation Criteria for Three Time Snapshots
Shown by Dotted Lines in FIG. 10

| Evaluation criteria | 3 | 6 | 9 |
|---|---|---|---|
| RMSE | 5.343142e−02 | 5.884118e−02 | 7.064205e−02 |
| CC | 9.982448e−01 | 9.990231e−01 | 9.984719e−01 |

It can be seen from Table 3 that RMSE is close to 0 and CC is close to 1, and the proposed C-PINN has good performance in solving the temperature distribution of the 1-D bounded string with the unknown external heat source.

Embodiment 4 The temperature distribution of a 2-D sheet under an unknown external heat source is solved, that is, the following 2-D Poisson equation with an unknown external source term is solved:

$$\frac{{\partial }^{2} u}{\partial {x}^{2}} + \frac{{\partial }^{2} u}{\partial {y}^{2}} = {T}_{0} , 0 < x < 1 , 0 < y < 1 \qquad ( 16 )$$

$$u ( x , 0 ) = 0 , u ( x , b ) = T , 0 \leq x \leq 1$$

$$u ( 0 , y ) = 0 , u ( a , y ) = 0 , 0 \leq y \leq 1 ,$$

T=1, the source term T₀ is a constant and the analytical solution is

$$u ( x , y ) = \frac{4 T}{π} {\sum }_{k = 0}^{30} \frac{sin ( 2 k + 1 ) π x sinh ( 2 k + 1 ) π y}{( 2 k + 1 ) sinh ( 2 k + 1 ) π} - \frac{16 {T}_{0}}{{π}^{4}} {\sum }_{k = 0}^{30} {\sum }_{l = 0}^{30} \frac{sin ( 2 k + 1 ) π x sin ( 2 l + 1 ) π y}{( 2 k + 1 ) ( 2 l + 1 ) [ {( 2 k + 1 )}^{2} + {( 2 l + 1 )}^{2} ]} .$$

PDE in the residual form is obtained

$${f}_{s} ( x , y ) = \frac{{\partial }^{2} u}{\partial {x}^{2}} - \frac{{\partial }^{2} u}{\partial {y}^{2}} - {T}_{0} \qquad ( 17 )$$

Thus, the proposed C-PINN comprises two neural networks: NetU and NetG, wherein: (a) NetU is used for approximating the solution that satisfies (16), i.e., for solving the displacement distribution of the 2-D vibration sheet under the external driving force; and (b) the NetG is used for regularizing the training of NetU.

### 1. Construction of Loss Function:

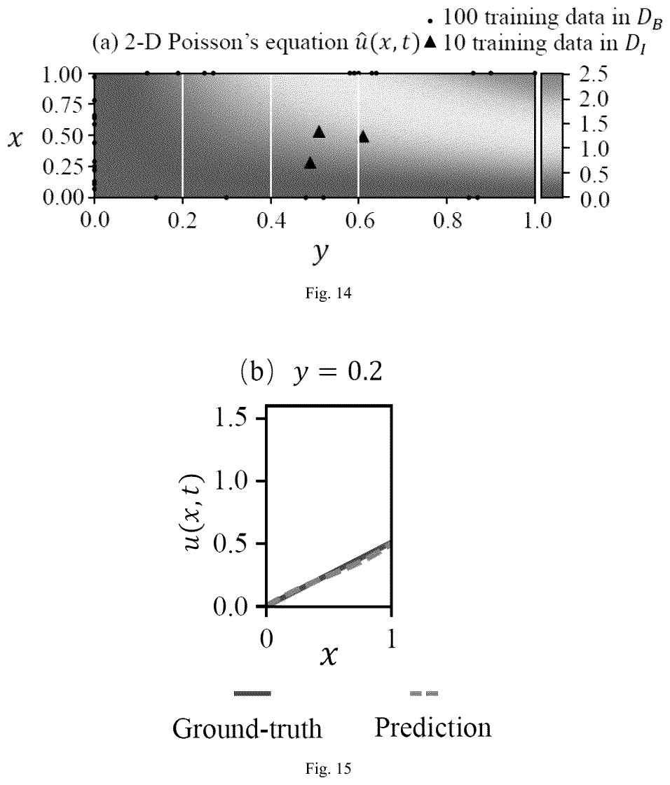

A training set is obtained from uniform random sampling in a system controlled by equation (16). In the present embodiment, a training set containing 30 boundary data and 3 internal collocation points are obtained from random uniform sampling in [0,1]×[0,1]. The training set is shown in FIG. 14. The structure of equation (16) is guaranteed by the collocation points. The proposed C-PINN is trained by the loss function in equation (3). MSE_{D} and MSE_{PN} represent the data-driven loss and the physics-informed loss of the given equation (16), respectively. Wherein MSE_{D} is obtained by equation (4), and û(x, y; ΘU) is a function of the network NetU whose training parameter set is ΘU. The MSEp is obtained by equation (5), and ĝ(x, y; Θ_{G}) is a function of the network NetG whose training parameter set is Θ_{G}. \hat{f}(x, y):=û(û(x, y)+ [symbol] (u(x, y); Θ_{U} is the approximation of the network NetU to g. The MSE_{PN} corresponds to the physics-informed loss of (17) on (16) of the finite set (x, y) E E of collocation points, used to regularize u in the network NetU to satisfy equation (16).

### 2. Hierarchical Training Strategy.

Considering the relation between the network NetU and the network NetG in the loss function MSE, the hierarchical training strategy is proposed. In many cases of practical application, the exact expression of g(x, y) cannot be obtained even by sparse measurements. However, the obtained sparse measurement data D_{I} within a region can be applied to regularize the structure of (16) to obtain \hat{Θ}G.

Therefore, Θ_{U} and Θ_{G} mutual dependence and are estimated through iteration estimation. Assuming k as the number of steps of the present iteration, the core problem of the hierarchical training strategy can be described by two optimization problems (6) and (7).

\hat{Θ}_{U}^{(k)} is a parameter set estimated by the network NetU at step k, Θ_{G}^{(k+1)} is a parameter set estimated by the network NetG at step k+1, and \hat{Θ}_{G}^{(k+1)} is used for describing the function û(x, y; \hat{Θ}_{U}^{(k+1)}). The details of the mutual iteration strategy can be described by algorithm 1:

### Algorithm 1: Hierarchical Optimization Coupling Strategy of C-PINN

Initialization: training data (x, t, u)∈D and collocation point (x, t)∈E are randomly sampled. The initialization parameter sets Θ_{U}⁽⁰⁾ and Θ_{G}⁽⁰⁾ of the network NetU and the network NetG are randomly generated, respectively.
Step 0: assuming that the k-step iteration has obtained the parameter sets Θ_{U}^{(k)} and Θ_{G}^{(k)}.

The following steps are repeated:
Stepk-1: obtaining \hat{Θ}_{G}^{(k+1)} by solving the optimization problem (6), where ûₜ(x, t; \hat{Θ}_{U}^{(k)})+ [symbol] (û(x, t; \hat{Θ}_{U}^{(k)}) in MSE_{PN} comes from the iterative result \hat{Θ}_{U}^{(k)} of the previous step.
Stepk-2: obtaining \hat{Θ}_{U}^{(k+1)} by solving the optimization problem (7), and using \hat{Θ}_{U}^{(k+1)} for predicting ĝ(x, t; Θ_{U}^{(k+1)}) in MSE_{PN}
Until stop criteria are satisfied, reaching a specified number of iterations or reaching error accuracy.
Returning \hat{Θ}_{U}→û(x, t; \hat{Θ}_{U}) for predicting a predicted value û(x, t) for any point (x, t) in Ω in equation (17).

It is noted that Θ_{U}⁽⁰⁾ and Θ_{G}⁽⁰⁾ are used for initialization of the given parameter set of the NetU and the parameter set of the NetG at step 1, respectively. In addition, the iterative transmission of the NetG and NetU parameter sets is also conducted in the algorithm.

### 3. Evaluation of Performance

The performance of the proposed C-PINN method in solving the 2-D Poisson equation with an unknown source term is evaluated. Equation (8) RMSE=1.594000e-02 indicates that the proposed C-PINN method has good performance in solving the unknown external heat source. u(x, y) and û(x, y) represent an actual sheet temperature distribution value and a corresponding predicted temperature distribution value respectively. CC=9.864411e-01 is used for further verifying the performance of the C-PINN.

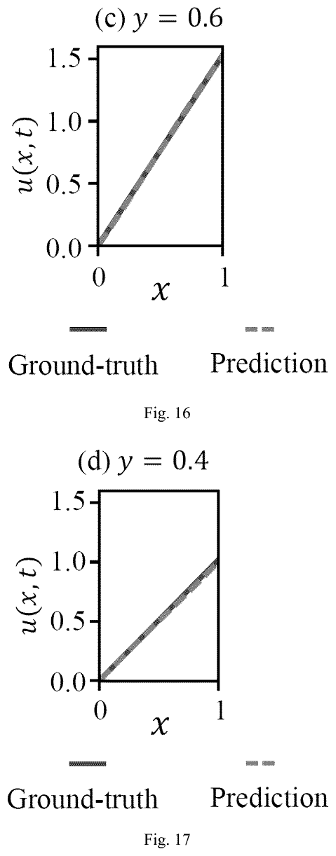

In the present embodiment, the relevant setting for the proposed C-PINN is that the number of hidden layers is 3 and each layer has 30 neurons. The scale of the predicted u(x, y) is shown in FIG. 14, and the specific comparison between the predicted and actual values of the snapshot maps at y=0.2, 0.4 and 0.6 is shown in FIG. 15-FIG. 17 respectively.

The evaluation criteria of prediction performance at y=0.2, 0.4 and 0.6 are shown in Table 4.

TABLE 4
Evaluation Criteria for Three Time Snapshots
Shown by Dotted Lines in FIG. 14

| Evaluation criteria | 0.2 | 0.4 | 0.6 |
|---|---|---|---|
| RMSE | 1.763408e−02 | 1.139888e−02 | 7.696680−02 |
| CC | 9.986055e−01 | 9.999703e−01 | 9.999656e−01 |

It can be seen from Table 4 that RMSE is close to 0 and CC is close to 1, and the proposed C-PINN has good performance in solving the temperature distribution of the 2-D sheet with the unknown external heat source.

Embodiment 5 The distribution of electromagnetic waves under the influence of an external source is solved, that is, the following 3-D Helmholtz equation is solved:

$$Δ u ( x ) + {p}^{2} u ( x ) = g ( x ) in Ω ⊂ {ℝ}^{3} \qquad ( 18 )$$

$$u ( x ) = {u}_{0} ( x ) on \partial Ω ,$$

$$Δ = \frac{\partial }{\partial {x}^{2}} + \frac{\partial }{\partial {y}^{2}} + \frac{\partial }{\partial {z}^{2}}$$

is a Laplacian operator, x=(x, y, z) is the coordinate of

$$x , y , z ∈ ( 0 , \frac{1}{4} ]$$

and p=5 is wave number. Appropriate g(x) is set so that the analytical solution is

$$u ( x ) = ( 0.1 sin ( 2 π x ) + tan h ( 10 x ) ) sin ( 2 π y ) sin ( 2 π z )$$

equation in the residual form is obtained

$${f}_{s} ( x ) = Δ u ( x ) + {k}^{2} u ( x ) - g ( x ) \qquad ( 19 )$$

Thus, the proposed C-PINN comprises two neural networks: NetU and NetG, wherein: (a) NetU is used for approximating the solution that satisfies (18), i.e., for solving the displacement distribution of electromagnetic waves under the external driving force; and (b) NetG is used for regularizing the training of NetU.

### 1. Construction of Loss Function:

A training set is obtained from uniform random sampling in a system controlled by equation (18). In the present embodiment, a training set is obtained from random uniform sampling in

$$[ 0 , \frac{1}{4} ] \times [ 0 , \frac{1}{4} ] \times [ 0 , \frac{1}{4} ] ,$$

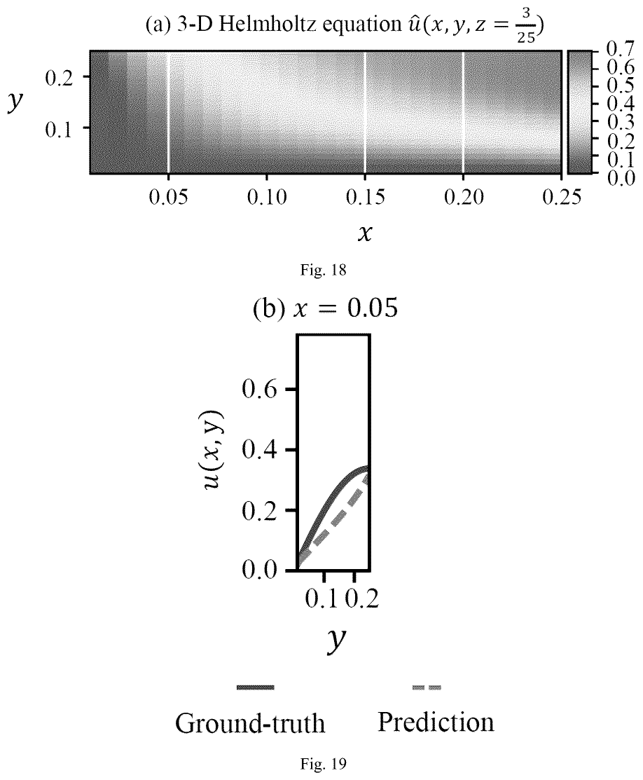

comprising 60 training data (x, y, z)∈D_{B} and 120 collocation points (x, y, z)∈E. The training set is shown in FIG. 18. The structure of equation (18) is guaranteed by the collocation points. The proposed C-PINN is trained by the loss function in (3). MSE_{D} and MSE_{PN} represent the data-driven loss and the physics-informed loss of the given equation (18), respectively. Wherein MSE_{D} is obtained by equation (4), and û(x, y, z; Θ_{U}) is a function of the network NetU/whose training parameter set is Θ_{U}. The MSEp is obtained by equation (5), and ĝ(x, y, z; Θ_{G}) is a function of the network NetG whose training parameter set is Θ_{G}. \hat{f}(x, y, z):=ûₜ(û(x, y, z))+ [symbol] (û(x, y, z) is the approximation of the network NetU to g. The MSE_{PN} corresponds to the physics-informed loss of (19) on (18) of the finite set (x, y, z)∈E of collocation points, used to regularize u in the network NetU to satisfy (18).

### 2. Hierarchical Training Strategy.

Considering the relation between the network NetU and the network NetG in the loss function MSE, the hierarchical training strategy is proposed. In many cases of practical application, the exact expression of g(x, y, z) cannot be obtained even by sparse measurements. However, the obtained sparse measurement data D_{I} within a region can be applied to regularize the structure of (18) to obtain \hat{Θ}_{G}.

Therefore, Θ_{U} and Θ_{G} mutual dependence and are estimated through iteration estimation. Assuming k as the number of steps of the present iteration, the core problem of the hierarchical training strategy can be described by two optimization problems (6) and (7).

\hat{Θ}_{U}^{(k)} is a parameter set estimated by the network NetU at step k, \hat{Θ}_{G}⁽⁺¹⁾ is a parameter set estimated by the network NetG at step k+1, and \hat{Θ}_{G}^{(k+1)} is used for describing the function û(x, y, z; \hat{Θ}_{U}⁽⁺¹⁾). The details of the mutual iteration strategy can be described by algorithm 1:

Algorithm 1 Hierarchical optimization coupling strategy of C-PINN
Initialization: training data (x, t, u)∈D and collocation point (x, t)∈E are randomly sampled. The initialization parameter sets Θ_{U}⁽⁰⁾ and Θ_{G}⁽⁰⁾ of the network NetU and the network NetG are randomly generated, respectively.
Step 0: assuming that the k-step iteration has obtained the parameter sets Θ_{U}^{(k)} and Θ_{G}^{(k)}.

The following steps are repeated:
Stepk-1: obtaining \hat{Θ}_{G}^{(k+1)} by solving the optimization problem (6), where ûₜ(x, t; \hat{Θ}_{U}^{(k)})+ [symbol] (û(x, t; \hat{Θ}_{U}^{(k)}) in MSE_{PN} comes from the iterative result \hat{Θ}_{U}^{(k)} of the previous step.
Stepk-2: obtaining \hat{Θ}_{U}^{(k+1)} by solving the optimization problem (7), and using \hat{Θ}_{U}^{(k+1)} for predicting ĝ(x, t; Θ_{U}^{(k+1)}) in MSE_{PN}
Until stop criteria are satisfied, reaching a specified number of iterations or reaching error accuracy.
Returning \hat{Θ}_{U}→û(x, t; \hat{Θ}_{U}) for predicting a predicted value û(x, t) for any point (x, t) in Ω in equation (19).

It is noted that Θ_{U}⁽⁰⁾ and Θ_{G}⁽⁰⁾ are used for initialization of the given parameter set of the NetU and the parameter set of the NetG at step 1, respectively. In addition, the iterative transmission of the NetG and NetU parameter sets is also conducted in the algorithm.

### 3. Evaluation of Performance

The performance of the proposed C-PINN method in solving the 3-D Helmholtz equation with an unknown source term is evaluated. Equation (8) RMSE=1.192859e-02 indicates that the proposed C-PINN method has good performance in solving the unknown external heat source. u(x, y, z) and represent an actual 3-D space electromagnetic wave distribution value and a corresponding predicted electromagnetic wave distribution value respectively. CC-9.057524e-01 is used for further verifying the performance of the C-PINN.

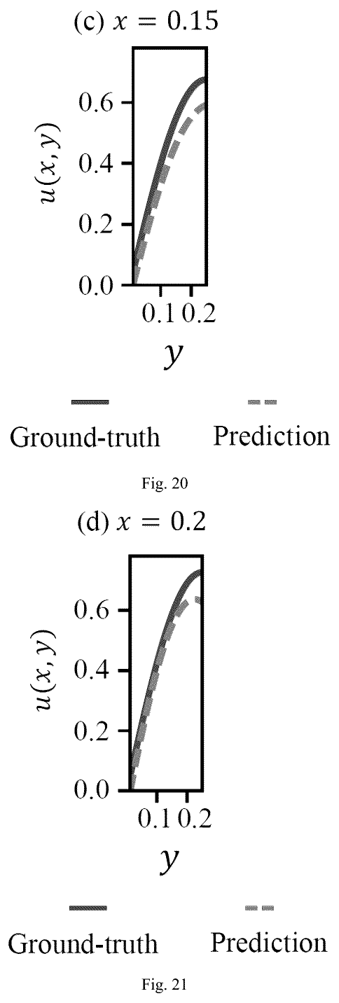

In the present embodiment, the relevant setting for the proposed C-PINN is that the number of hidden layers is 3 and each layer has 100, 50, and 50 neurons respectively. The <snapshot map of the predicted û(x, y, z=0.12) is shown in FIG. 18, and the comparison between the predicted and actual values of the snapshot maps at (x=0.05, z=0.12), (x=0.15, z=0.12), and (x=0.2, z=0.12) is shown in FIG. 19-FIG. 21 respectively.

The evaluation criteria of prediction performance at (x=0.05, z=0.12), (x=0.15, z=0.12) and (x=0.2, z=0.12) are shown in Table 5.

TABLE 5
Evaluation Criteria for Three Time Snapshots
Shown by Dotted Lines in FIG. 18

| Evaluation criteria | 0.05 | 0.15 | 0.2 |
|---|---|---|---|
| RMSE | 7.043735e−02 | 7.548533e−02 | 5.179414e−02 |
| CC | 9.604538e−01 | 9.998589e−01 | 9.964517e−01 |

It can be seen from Table 5 that RMSE is close to 0 and CC is close to 1, and the proposed C-PINN has good performance in solving the 3-D electromagnetic wave distribution under the unknown external electromagnetic source.

The above embodiments only express the implementation of the present invention, and shall not be interpreted as a limitation to the scope of the patent for the present invention. It should be noted that, for those skilled in the art, several variations and improvements can also be made without departing from the concept of the present invention, all of which belong to the protection scope of the present invention.

1. A coupled physics-informed neural network for solving displacement distribution of a bounded vibration string under an unknown external driving force, wherein the proposed coupled physics-informed neural network C-PINN is used for solving the following partial differential equation:
$${u}_{t} ( x , t ) + 𝒩 [ u ( x , t ) ] = g ( x , t ) , \qquad ( 1 )$$
$$x ∈ Ω ⊆ {ℝ}^{d} ,$$
$$t ∈ [ 0 , T ] ⊂ ℝ ,$$
that is, x is a spatial variable of the bounded string, t is a vibration time variable and is in an initial state when t=0, uₜ(x, t) is the first-order differential of the displacement with respect to t, u: [symbol] ^{d}× [symbol] → [symbol] is the solution of the equation, i.e., the displacement distribution, and g: [symbol] ^{d}× [symbol] → [symbol] is the source term in a general form, i.e., the external driving force, comprising linear, nonlinear, and steady or dynamic; Ω is a spatial open set of the bounded string, and [symbol] [⋅] is a series of partial differential operators, i.e., a series of states of the bounded vibration string changing with time and space;
equation (1) can be written as the following form of residual function:
$${f}_{N} ( x , t ) := f ( x , t ) - g ( x , t ) = {u}_{t} ( x , t ) + 𝒩 [ u ( x , t ) ] - g ( x , t ) . \qquad ( 2 )$$
the objective of the constructed coupled physics-informed neural network C-PINN is to approximate the displacement distribution of the bounded vibration string under the unknown external driving force, that is, to solve the partial differential equation with an unknown source term described in (1); thus, the proposed C-PINN comprises two neural networks: NetU and NetG, wherein: (a) NetU) is used for approximating the solution that satisfies (1); and (b) NetG is used for regularizing the training of NetU;
step 1: constructing a loss function for training C-PINN;
to train the proposed C-PINN, a training set is obtained by uniform random sampling from the bounded vibration string under unknown external driving, wherein a training dataset is represented by D, D is composed of boundary and initial training data D_{B} and internal training data D_{I}, and D_{B}∩D₁=Ø; E represents a set (x, t) of collocation points corresponding to (x, t, u)∈D_{I}; a data-physics-hybrid loss function shown in equation (3) is used for training the proposed C-PINN;
$$MSE = {MSE}_{D} + {MSE}_{PN} \qquad ( 3 )$$
wherein MSE_{D} and MSE_{PN} represent the data-driven loss and the physics-informed loss of a given equation (1), respectively, which is a general nonhomogeneous partial differential equation; the MSE_{D} is obtained from the following equation:
$${MSE}_{D} = {\sum }_{( x , t , u ) ∈ D} {( \hat{u} ( x , t ; {\hat{Θ}}_{U} ) - u ( x , t ) )}^{2} \qquad ( 4 )$$
wherein û(x, t; Θ_{U}) is a function of the network NetU whose training parameter set is Θ_{U};
MSE_{PN} is obtained from the following equation:
$${MSE}_{PN} = {\sum }_{( x , t ) ∈ E} {( \hat{f} ( x , t ) - \hat{g} ( x , t ; {\hat{Θ}}_{G} ) )}^{2} \qquad ( 5 )$$
wherein ĝ(x, t; Θ_{G}) is a function of the network NetG whose training parameter set is Θ_{G}; \hat{f}(x, t):=ûₜ(û(x,t)+ [symbol] (û(x,t) which is the approximation of the network NetU for g; MSE_{PN} corresponds to the physics-informed loss of (2) on (1) of the nonhomogeneous partial differential equation on a finite set (x, t)∈E of collocation points, used to regularize u in NetU/to satisfy equation (1);
step 2: optimizing and coupling the proposed C-PINN by a hierarchical training strategy to predict the displacement of the bounded vibration string under the external driving force over time at <any position, i.e., solve equation (1) to obtain the predicted value u(x,t) at any point (x, t);
the sparse displacement distribution of the bounded string driven by an external force is sampled by using a displacement sensor in the position where it is convenient to install the displacement sensor inside the bounded string, i.e., the obtained sparse measurement data D_{I} within a region is applied to regularize the structure of (1) to obtain \hat{Θ}c;
therefore, Θ_{U} and Θ_{G} are iteratively estimated with mutual dependence; assuming k as the number of steps of the present iteration, the core problem of the hierarchical training strategy can be described by the following two optimization problems;
$$\begin{matrix}{\hat{Θ}}_{G}^{( k + 1 )} = {arg min}_{{Θ}_{G}} \{ {MSE}_{D} ( {\hat{Θ}}_{U}^{( k )} ) + {MSE}_{PN} ( {Θ}_{G} ; {\hat{Θ}}_{U}^{( k )} ) \} \\ = {arg min}_{{Θ}_{G}} {MSE}_{PN} ( {Θ}_{G} ; {\hat{Θ}}_{U}^{( k )} )\end{matrix} \qquad ( 6 )$$
$$and$$
$${\hat{Θ}}_{U}^{( k + 1 )} = {arg min}_{{Θ}_{U}} \{ {MSE}_{D} ( {Θ}_{U} ) + {MSE}_{PN} ( {Θ}_{U} ; {\hat{Θ}}_{G}^{( k + 1 )} ) \} , \qquad ( 7 )$$
wherein \hat{Θ}_{U}^{(k)} is a parameter set estimated by the network NetU at step k, \hat{Θ}_{G}^{(k+1)} is a parameter set estimated by the network NetG at step k+1, and \hat{Θ}_{G}^{(k+1)} is used for describing the function û(x, t; \hat{Θ}_{U}^{(k+1)};
step 3: evaluating the performance of the proposed C-PINN method in solving the displacement distribution of the bounded vibration string under the unknown external driving force, that is, the performance when the PDE with unknown source term is solved in equation (1);
the root mean squared error (RMSE) is used for evaluating the performance of the proposed C-PINN method in predicting the displacement distribution of the bounded vibration string under the unknown external driving force; and to further verify the performance of the proposed C-PINN, the Pearson correlation coefficient CC is used for calculating the similarity between an actual displacement distribution value and a predicted displacement distribution value.

2. The coupled physics-informed neural network for solving displacement distribution of the bounded vibration string under the unknown external driving force according to claim 1, wherein multiple types of dynamic systems with spatiotemporal dependence under external driving can be described by equation (1), and in addition to the displacement distribution of the bounded vibration string under the external driving force, also comprises: (a) a heat diffusion system; and (b) a 3-D Helmholtz equation.

3. The coupled physics-informed neural network for solving displacement distribution of the bounded vibration string under the unknown external driving force according to claim 1, wherein in step 2, based on the two core optimization problems of the above hierarchical training strategy, algorithm 1 is used for specifically describing the hierarchical strategy; the strategy is specifically as follows:
algorithm 1: Hierarchical Optimization Coupling Strategy of C-PINN:
Initialization: training data (x, t, u)∈D and collocation point (x, t)∈E are randomly sampled in a bounding string vibration system, initialization parameter sets Θ_{U}⁽⁰⁾ and Θ_{G}⁽⁰⁾ of the network NetU and the network NetG are randomly generated, respectively;
step 0: assuming that the k-step iteration has obtained the parameter sets Θ_{U}^{(k)} and Θ_{G}^{(k)};
the following steps are repeated:
stepk-1: obtaining \hat{Θ}_{G}^{(k+1)} by solving the optimization problem (6), where ûₜ(x, t; \hat{Θ}_{U}^{(k)})+ [symbol] (û(x, t; \hat{Θ}_{U}^{(k)}) in MSE_{PN} comes from the iterative result \hat{Θ}_{U}^{(k)} of the previous step;
stepk-2: obtaining \hat{Θ}_{U}^{(k+1)} by solving the optimization problem (7), and using \hat{Θ}_{U}^{(k+1)} for predicting ĝ(x, t; Θ_{U}^{(k+1)}) in MSE_{PN};
until stop criteria are satisfied, reaching a specified number of iterations or reaching error accuracy;
returning \hat{Θ}_{U}→û(x, t; \hat{Θ}_{U}) for predicting a predicted value û(x, t) for any point (x, t) in Ω in equation (2);
it is noted that Θ_{U}⁽⁰⁾ and Θ_{G}⁽⁰⁾ are used for initialization of the given parameter set of the NetU and the parameter set of the NetG at -Step 0 respectively; in addition, the iterative transmission of the NetG and NetU parameter sets is also conducted in the algorithm.

4. The coupled physics-informed neural network for solving displacement distribution of the bounded vibration string under the unknown external driving force according to claim 1, wherein in step 3, the equation of the root mean squared error (RMSE) is as follows:
$$RMSE = \sqrt{\frac{1}{\vert T \vert} {\sum }_{( x , t ) ∈ T} {( u ( x , t ) - \hat{u} ( x , t ) )}^{2}} \qquad ( 8 )$$
wherein |T| is a cardinality of a test set (x, t)∈T of collocation points; u(x, t) and û(x, t) represent an actual displacement distribution value and a corresponding predicted displacement distribution Value, respectively; the closer the value of the RMSE is to 0, the better the performance of the proposed C-PINN is.

5. The coupled physics-informed neural network for solving displacement distribution of the bounded vibration string under the unknown external driving force according to claim 1, wherein in step 3, the equation of the Pearson correlation coefficient CC is as follows:
$$CC = \frac{cov ( u ( x , t ) , \hat{u} ( x , t ) )}{\sqrt{Var u ( x , t )} \sqrt{Var \hat{u} ( x , t )}} \qquad ( 9 )$$
wherein CC is the correlation coefficient of u(x, t) and û(x,t), and cov (u(x, t), û(x, t)) is the covariance of u(x, t) and û(x, t); Var u(x,t) and
$$\sqrt{Var \hat{u} ( x , t )}$$
are variances of u(x, t) and û(x,t), respectively; the closer the value of the CC is to 1, the better the performance of the proposed C-PINN is.
